(19) United States
(12) Patent Application Publication
(10) Pub. No.: US 2006/0164587 A1
(43) Pub. Date: Jul. 27, 2006

(54) Display panel assembly and display apparatus having the same

(76) Inventor: Se-Chun Oh, Seongnam-si (KR)

Correspondence Address: CANTOR COLBURN, LLP, 55 GRIFFIN ROAD SOUTH, BLOOMFIELD, CT, 06002, US

(21) Appl. No.: 11/320,020

(22) Filed: Dec. 28, 2005

(30) Foreign Application Priority Data
Jan. 25, 2005 (KR) 2005-006571

(51) Int. Cl. G02F 1/1345

(52) U.S. Cl. 349/152

(57) ABSTRACT

A display panel assembly includes a display panel, a source printed circuit board (“PCB”), a main path unit, and a sub path unit. The display panel displays an image in response to a data signal and a gate signal generated based on a driving voltage. The source PCB is disposed in a peripheral region of the display panel and mounts a driving circuit unit outputting the driving voltage. The main path unit transmits the driving voltage to the display panel, and the sub path unit transmits the driving voltage to the display panel. Therefore, drive reliability may be improved by employing a sub path unit additionally transmitting the gate driving voltage to the display panel.

This application claims priority to Korean Patent Application No. 2005-6571, filed on Jan. 25, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a display panel assembly and a display apparatus having the display panel assembly. More particularly, the present invention relates to a display panel assembly capable of improving drive reliability and a display apparatus having the display panel assembly.

2. Description of the Related Art

Generally, a liquid crystal display (“LCD”) apparatus includes an LCD panel and a driving circuit unit outputting a drive signal to drive the LCD panel.

The LCD panel includes a thin film transistor (“TFT”) substrate including a plurality of TFTs arranged in a matrix shape, a color filter substrate combined with the TFT substrate, and a liquid crystal layer disposed between the TFT substrate and the color filter substrate. The TFT substrate includes a plurality of gate lines for accepting gate signals and a plurality of data lines for accepting data signals, the data lines arranged in a substantially perpendicular direction with respect to the gate lines and insulated from the gate lines.

The apparatus includes a source printed circuit board (“PCB”), a plurality of tape carrier packages (“TCPs”) for electrically coupling the TFT substrate to the source PCB and a plurality of gate TCPs coupled to the gate lines of the TFT substrate.

Each of the data TCPs includes a data driver chip for driving the data lines of the TFT substrate and each of the gate TCPs includes a gate driver chip for driving the gate lines of the TFT substrate.

The source PCB outputs data driving signals and gate driving signals applied to the data driver chip and the gate driver chip in order to drive the data driver chip and the gate driver chip, respectively.

The gate driving signals provided to the gate driver chip are applied to a first gate TCP through a first data TCP. The gate driving signals are sequentially applied from the first gate TCP to the last gate TCP to drive each gate driver chip.

The gate driving signals include a gate turn-on voltage for turning-on switching device TFTs that are electrically coupled to the gate lines, and a gate turn-off voltage for turning-off the switching device TFTs that are electrically coupled to the gate lines.

When the gate driving signals are applied to the gate driver chip through the first data TCP as described above, an adhesive defect may occur between the first data TCP and the TFT substrate due to a long-term drive. As a result, a disconnection may occur at a portion where the driving voltage is applied.

### BRIEF SUMMARY OF THE INVENTION

The present invention provides a display panel assembly for improving drive reliability.

The present invention also provides a display apparatus having the display panel assembly.

In exemplary embodiments of the present invention, a display panel assembly includes a display panel, a source printed circuit board (“PCB”), a main path unit, and a sub path unit. The display panel displays an image in response to a data signal and a gate signal generated based on a driving voltage. The source PCB is disposed in a peripheral region of the display panel and mounts a driving circuit unit that outputs the driving voltage. The main path unit is transmits the driving voltage to the display panel. The sub path unit transmits the driving voltage to the display panel.

The main path unit may include a first output line unit transmitting the driving voltage outputted from the driving circuit unit to a first data tape carrier package (“TCP”) and a first connect line unit applying the driving voltage transmitted from the first data TCP to a first gate TCP.

For example, the first output line unit and the first connect line unit are coupled to each other via a dummy pattern unit of the first data TCP.

The sub path unit may include a second output line unit transmitting the driving voltage outputted from the driving circuit unit to a second data TCP and a second connect line unit transmitting the driving voltage outputted from the second data TCP to a second gate TCP. The second output line unit and the second connect line unit may be electrically coupled to each other via a dummy pattern unit of the second data TCP.

For example, the second connect line unit includes a repairing line unit surrounding a portion of a display region of the display panel where an image is substantially displayed and a third connect line unit coupling the repairing line unit to the second gate TCP.

The display panel includes the display region where an image is substantially displayed and a peripheral region surrounding the display region, and the peripheral region includes a gate driver having a plurality of stages electrically coupled to one another and applying the gate signals to the display region of the display panel.

The main path unit may include a first output line unit transmitting the driving voltage outputted from the driving circuit unit to a first data TCP and a first input terminal unit applying the driving voltage transmitted from the first data TCP to a first stage of the plurality of stages.

For example, the first output line unit and the first input terminal unit are electrically coupled to each other via a dummy pattern unit of the first data TCP.

The sub path unit may include a second output line unit transmitting the driving voltage outputted from the driving circuit unit to a second data TCP, a second connect line unit transmitting the driving voltage transmitted from the second data TCP to the gate driver, and a second input terminal unit transmitting, the driving voltage transmitted from the second connect line unit to a second stage of the plurality of stages.

For example, the second connect line unit includes a repairing line unit surrounding a portion of the display region and the repairing line unit repairs data lines formed in the display region.

The main path unit may extend between a first data TCP and a first gate TCP, and the sub path unit may extend between a second data TCP and a second gate TCP.

The sub path unit may surround a plurality of sides of a display region of the display panel. The display panel includes a first side, a second side, a third side, and a fourth side, the first side opposite the second side and the third side opposite the fourth side. The source printed circuit board may be positioned adjacent the first side of the display panel, a gate driver may be positioned adjacent the third side of the display panel, and the sub path unit may extending adjacent the second and fourth sides of the display panel.

In the display panel assembly of the exemplary embodiments, if an error occurs in the main path unit, the sub path unit transmits the driving voltage.

In other exemplary embodiments of the present invention, a display panel assembly includes a driving circuit unit, a first output line unit, a second output line, a gate driver, and a repairing line unit.

The driving circuit unit is mounted on a source PCB disposed in a peripheral region of a display panel and outputs a driving voltage to the display panel. The first output line unit transmits the driving voltage outputted from the driving circuit unit to a first data TCP. The second output line unit transmits the driving voltage outputted from the driving circuit unit to a second data TCP. The gate driver outputs a gate signal to a display region of the display panel based on the driving voltage. The repairing line unit transmits the driving voltage transmitted from the second data TCP to the gate driver.

For example, the gate driver includes a plurality of gate TCPs, where the driving voltage applied to the first data TCP is transmitted to a first gate TCP, and the driving voltage transmitted to the second data TCP is transmitted to a second gate TCP.

Alternatively, the gate driver includes a shift register having a plurality of stages that are electrically coupled to one another. The driving voltage transmitted to the first data TCP is applied to a first stage of the shift register, and the driving voltage transmitted to the second data TCP is transmitted to a second stage of the shift register.

In still other exemplary embodiments of the present invention, a display apparatus includes a display panel assembly and a backlight assembly.

The display panel assembly of the display apparatus has a driving circuit unit mounted on a source PCB disposed in a peripheral region of a display panel and outputting a driving voltage, a gate driver outputting a gate signal to a display region of the display panel based on the driving voltage, a main path unit transmitting the driving voltage to the gate driver, and a sub path unit transmitting the driving voltage to the gate driver. The backlight assembly emits a light to the display panel.

The main path unit may include a first output line unit disposed on the source PCB and transmits the driving voltage outputted from the driving circuit unit to a first data TCP.

The sub path unit may include a second output line unit disposed on the source PCB and transmitting the driving voltage outputted from the driving circuit unit to a second data TCP, and a repairing line unit disposed on the display panel and transmitting the driving voltage transmitted from the second data TCP to the gate driver.

The gate driver may include a plurality of gate TCPs, or, alternatively, the gate driver may include a shift register having a plurality of stages that are electrically coupled to one another.

In other exemplary embodiments of the present invention, a display panel assembly includes a main path unit transmitting a driving voltage to a first portion of a gate driver and a sub path unit transmitting the driving voltage to a second portion of the gate driver, the sub path unit including an auxiliary line within a repairing line unit.

The first portion of the gate driver may be a first gate TCP and the second portion of the gate driver may be a second gate TCP.

Alternatively, the gate driver may include a plurality of shift registers, where the first portion of the gate driver is a first input terminal on a first end of the gate driver, and the second portion of the gate driver is a second input terminal on a second end of the gate driver.

The main path unit may extend from a first data TCP, and the sub path unit may extend from a second data TCP.

A source printed circuit board may be disposed on a first side of the display panel and a driving circuit unit outputting the driving voltage may be disposed on the source printed circuit board. The gate driver may be disposed on a third side of the display panel, and the sub path unit may extend adjacent a fourth side of the display panel opposite the third side and may further extend adjacent a second side of the display panel opposite the first side.

According to the display panel assembly and the display apparatus having the same, drive reliability may be improved by employing a sub path in addition to a main path transmitting the gate-on voltage to the gate driver chip.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view schematically illustrating an exemplary embodiment of a display panel assembly according to the present invention;

FIG. 2 is an enlarged view illustrating portion ‘I’ shown in FIG. 1;

FIG. 3 is an enlarged view illustrating portion ‘II’ shown in FIG. 1;

FIG. 4 is an enlarged view illustrating portion ‘III’ shown in FIG. 1;

FIG. 5 is a plan view schematically illustrating another exemplary embodiment of a display panel assembly according to the present invention;

FIG. 6 is a block diagram illustrating an exemplary gate driver circuit shown in FIG. 5 and an exemplary transmission path of a driving voltage; and

FIG. 7 is an exploded perspective view schematically illustrating an exemplary embodiment of a display apparatus according to the present invention.

### DETAILED DESCRIPTION OF THE INVENTION

Hereinafter, the present invention will be explained in detail with reference to the accompanying drawings. In the drawings, certain features may be exaggerated for clarity. Like numerals refer to like elements throughout.

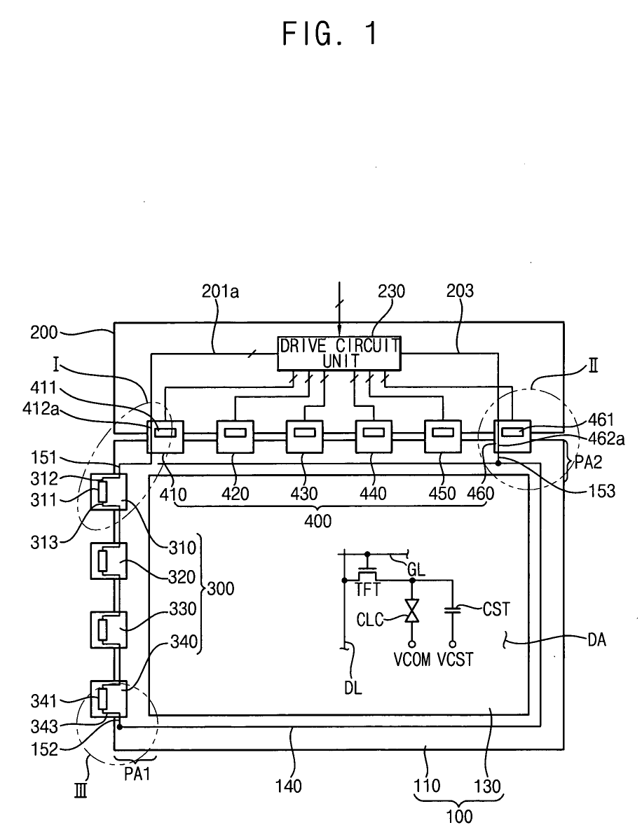

FIG. 1 is a plan view schematically illustrating an exemplary embodiment of a display panel assembly according to the present invention.

Referring to FIG. 1, the display panel assembly includes a display panel 100, a source printed circuit board (“PCB”) 200, a driving circuit unit 230, a repairing line unit 140, a gate driver 300, and a data driver 400. The gate driver 300 includes a plurality of gate tape carrier packages (“TCPs”) 310, 320, 330, and 340, and the data driver 400 includes a plurality of data TCPs 410, 420, 430, 440, 450, and 460. While the illustrated embodiment includes four gate TCPs and six data TCPs, it should be understood that alternate quantities of gate TCPs and data TCPs may be included in these embodiments.

The display panel 100 includes a lower substrate 110, an upper substrate 130, and a liquid crystal layer (not shown) disposed between the lower substrate 110 and the upper substrate 130. The lower substrate 110 includes a plurality of gate lines GL arranged in a first direction and a plurality of data lines DL arranged in a second direction crossing with the first direction. The data lines DL may be arranged substantially perpendicular to the gate lines GL and may be insulated from the gate lines GL such as by an insulating layer included in the lower substrate 110.

The lower substrate 110 includes a plurality of pixels each defined by an adjacent pair of the gate lines GL and an adjacent pair of the data lines DL. Each of the pixels includes a switching device TFT, a first pixel electrode of a liquid crystal capacitor CLC, and a storage capacitor CST. The pixels are formed in a display region DA for displaying an image.

The upper substrate 130 is combined with the lower substrate 110, such as by, for example, a sealing portion positioned peripherally between the upper substrate 130 and the lower substrate 110, and the liquid crystal layer is disposed between the upper substrate 130 and the lower substrate 110. The upper substrate 130 includes a common electrode that corresponds to the pixel electrode of the lower substrate 110. The upper substrate 130 is correspondingly disposed to the display region DA.

The display panel 100 may be generally rectangular shaped as illustrated, with a first side and an opposite second side, a third side connecting the first side to the second side, and a fourth side connecting the first side to the second side and opposite the third side. The source PCB 200 is disposed in a peripheral region of the display panel 100, such as along a first side of the display panel 100, and the driving circuit unit 230 is formed on the source PCB 200. The source PCB 200 includes a plurality of output lines corresponding to an output terminal of the driving circuit unit 230.

The output terminal of the driving circuit unit 230 outputs a gate-on voltage VON, and is electrically coupled to a first output line 201a and a second output line 203, respectively. The first output line 201a is electrically coupled to a dummy pattern 412a of the first data TCP 410, and the second output line 203 is electrically coupled to a dummy pattern of another data TCP, not including the first data TCP 410.

In the illustrated, embodiment, for example, the second output line 203 is electrically coupled to a dummy pattern 462a of the sixth and last data TCP 460. Accordingly, the gate-on voltage VON is applied to the dummy pattern 412a of the first data TCP 410 and the dummy pattern 462a of the last data TCP 460 via the first output line 201a and the second output line 203, respectively.

The driving circuit unit 230 generates a driving signal for driving the display panel 100 based on a signal provided from an external device as illustrated by the arrow pointing to the driving circuit unit 230. The driving circuit unit 230 includes a gate-on voltage VON, a gate-off voltage VOFF, and a common voltage generator that generates common voltages VCOM and VCST. The gate-on/off voltages VON/VOFF are applied to gate driver chips mounted on the gate TCPs 310 through 340, such as gate driver chips 311 and 341, and the common voltages VCOM and VCST are applied to the display panel 100.

The repairing line unit 140 is disposed on the lower substrate 110 in an outside region of the display region DA such that the repairing line unit 140 surrounds the display region DA. In one exemplary embodiment, the repairing line unit 140 may extend adjacent first, second, and fourth sides of the display panel 100, while the gate TCPs are arranged along a third side of the display panel 100. The repairing line unit 140 includes at least two repairing lines, as will be further described below.

The gate TCPs 310, 320, 330 and 340 are arranged along a first direction at a first peripheral region PA1 of the lower substrate 110. The first peripheral region PA1 may be located adjacent a third side of the display panel 100. Each of the gate TCPs 310, 320, 330, and 340 includes a gate driver chip applying gate signals to gate lines GL. As illustrated, the gate TCP 310 includes the gate driver chip 311 applying gate signals to the gate lines GL. The gate TCP 310 also includes an input pattern unit 312 receiving a gate control signal from a first connect line 151, where the first connect line 151 connects the input pattern unit 312 and a dummy pattern unit including the dummy pattern 412a. The gate TCP 310 further includes an output pattern unit 313 transferring the gate control signal to a next gate TCP. For example, the output pattern unit 313 passes the gate control signal to an input pattern unit of gate TCP 320, an output pattern unit of gate TCP 320 passes the gate control signal to an input pattern unit of gate TCP 330, etc. The gate control signal includes a clock signal, a gate-on voltage VON, and a gate-off voltage VOFF.

The gate control signal is outputted from the driving circuit unit 230 of the source PCB 200, and the gate control signal is applied to the first gate driver chip 311 via the input pattern unit 312 of the first gate TCP 310 by passing successively through the first output line 201a, the dummy pattern 412a, the first connect line 151, and the input pattern unit 312 to the first gate driver chip 311.

The gate driver chip 311 generates a predetermined number of the gate signals based on the gate control signal to apply the gate signals to corresponding gate lines. Thus, each of the gate TCPs applies gate signals to a next gate TCP according to the gate control signals provided from a previous gate TCP. Since the gate TCP 310 does not have a previous gate TCP, gate TCP 310 receives its gate control signals from the driving circuit unit 230 as previously described.

The last gate TCP 340 includes an input pattern unit 341 receiving gate signals from an output pattern unit of the third gate TCP 330, and an output pattern unit 343. The output pattern unit 343 may be electrically connected to a pattern, such as second connect line 152, where a gate-on voltage is outputted among patterns of the output pattern unit 343 in the last gate TCP 340. The second connect line 152 is electrically coupled to an arbitrary repair line (also referred to as an ‘auxiliary line’) among the repair lines of the repairing line unit 140. The connect line 152, which receives the gate-on voltage outputted among patterns of the output pattern unit 343 and which is electrically coupled to the auxiliary line of the repairing line unit 140, is formed on the lower substrate 110.

The data TCPs 410 through 460 are arranged in the second direction at a second peripheral region PA2 of the lower substrate 110. The data TCPs 410 through 460 and the second peripheral region PA2 may be located adjacent the first side of the display panel 100. Each of the data TCPs 410 through 460 includes a data driver chip applying a data signal to a data line. The data TCP 410 includes a data driver chip 411 applying a data signal to a data line. Each of the data TCPs 410 through 460 includes an input pattern unit where a signal is inputted from the driving circuit unit 230 and an output pattern unit where a processed signal is outputted. The data TCP 410 further includes a dummy pattern unit 412 including the dummy pattern 412a.

The gate control signals outputted from the driving circuit unit 230 are applied to the input pattern unit 312 of the first gate TCP 310 via the dummy pattern unit 412, which includes the previously described dummy pattern 412a, of the first data TCP 410.

The dummy pattern unit 412 of the first data TCP 410 and the input pattern unit 312 of the first gate TCP 310 are electrically coupled to each other by first connect lines 151 formed on the lower substrate 110.

An arbitrary dummy pattern 462a among dummy patterns of the last data TCP 460 is coupled to an output terminal where a gate-on voltage is outputted among output terminals of the driving circuit unit 230. The arbitrary dummy to pattern 462a is electrically connected to the second output line 203, and as illustrated, does not pass through the driving chip 461 of the data TCP 460. Instead, the arbitrary dummy pattern 462a is electrically coupled to the auxiliary line of the repairing line unit 140 via a third connect line 153 formed on the lower substrate 110.

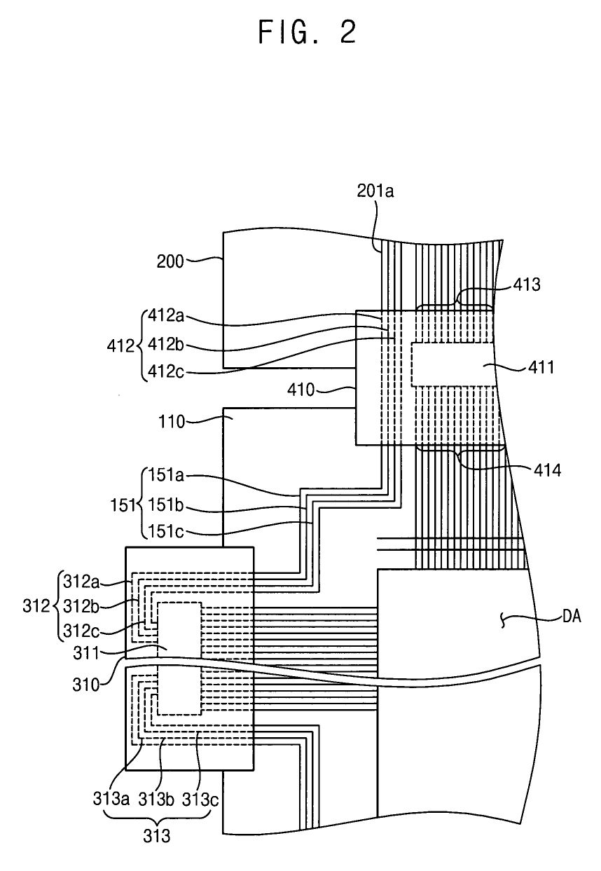

FIG. 2 is an enlarged view illustrating portion ‘I’ shown in FIG. 1.

Referring to FIGS. 1 and 2, a main path for providing the gate-on voltage outputted from the driving circuit unit 230 to a plurality of the gate TCPs includes, in part, the first output line 201a, the first data TCP 410, and the first gate TCP 310.

More particularly, the first data TCP 410 includes a data driver chip 411, a dummy pattern unit 412, an input pattern unit 413 electrically coupled to an input terminal of the data driver chip 411 and an output pattern unit 414 electrically coupled to an output terminal of the data driver chip 411. One end of the first data TCP 410 is electrically coupled to the source PCB 200, and another end of the first data TCP 410 is electrically coupled to the lower substrate 110.

The data driver chip 411 converts a data signal to an analog data voltage to apply the data voltage to data lines DL of the display panel 100. The dummy pattern unit 412 receives gate control signals outputted from the driving circuit unit 230 disposed on the source PCB 200. The gate control signals include a clock signal, a gate-on voltage VON, and a gate-off voltage VOFF, and the dummy pattern unit 412 includes a plurality of dummy patterns 412a, 412b, and 412c corresponding to the gate control signals.

The first dummy pattern 412a is formed on the first data TCP 410, is electrically coupled to the first output line 201a transmitting the gate-on voltage VON outputted from the driving circuit unit 230, and transmits the gate-on voltage VON. The second dummy pattern 412b transmits the gate-off voltage VOFF from the driving circuit unit 230 and the third dummy pattern 412c transmits the clock signal.

The first gate TCP 310 includes a gate driver chip 311, an input pattern unit 312, and an output pattern unit 313. The gate driver chip 311 generates gate signals to apply the gate signals to gate lines of the display panel 100 based on the gate control signals transmitted from the dummy pattern unit 412.

The input pattern unit 312 is electrically coupled to the dummy pattern unit 412 by a first connect line 151 formed on the lower substrate 110. The first connect line 151 may include three first connect line patterns 151a, 151b, and 151c connecting the dummy patterns 412a, 412 b, and 412c to the input patterns 312a, 312b, and 312c, respectively.

The input pattern unit 312 includes the first input pattern 312a, the second input pattern 312b, and the third input pattern 312c. The first input pattern 312a is electrically coupled to the first dummy pattern 412a to receive the gate-on voltage VON. The second input pattern 312b is electrically coupled to the second dummy pattern 412b to receive the gate-off voltage VOFF. The third input pattern 312c is electrically coupled to the third dummy pattern 412c to receive the clock signal.

The output pattern unit 313 is electrically coupled to the input pattern unit of the second gate TCP 320. The output pattern unit 313 includes a first output pattern 313a outputting a gate-on voltage VON, a second output pattern 313boutputting a gate-off voltage VOFF, and a third output pattern 313c outputting a clock signal.

As described above, the gate-on voltage VON transmitted from the first output line 201a passes through the first dummy pattern 412a of the first data TCP 410 and the first connect line 151a to be transmitted to the first gate TCP 310 through the first input pattern 312a. The gate TCPs 310, 320, 330 and 340 that are electrically coupled to one another receive the gate-on voltage VON via the main path, where the main path is defined in part by the first output line 201a, the dummy pattern 412a, the first connect line 151a, the input pattern 312a, and the successive output and input patterns of the following gate TCPs that carry the gate-on voltage VON from a previous gate TCP to a next gate TCP.

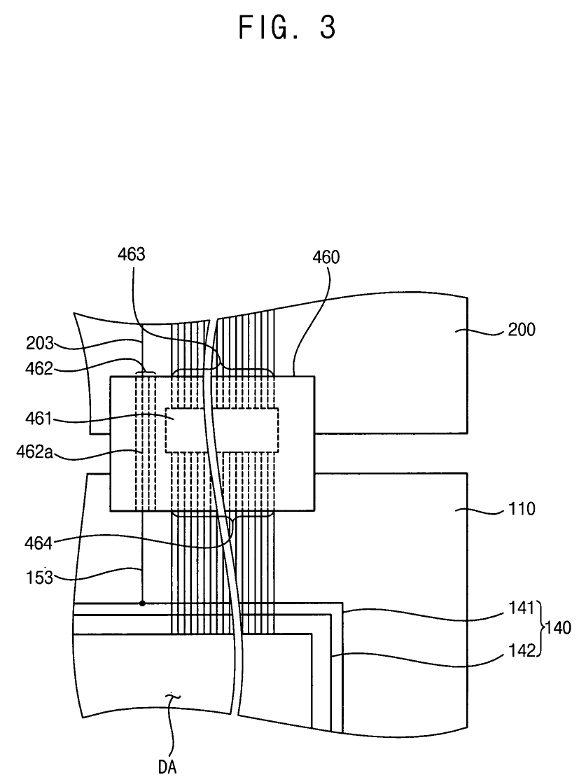

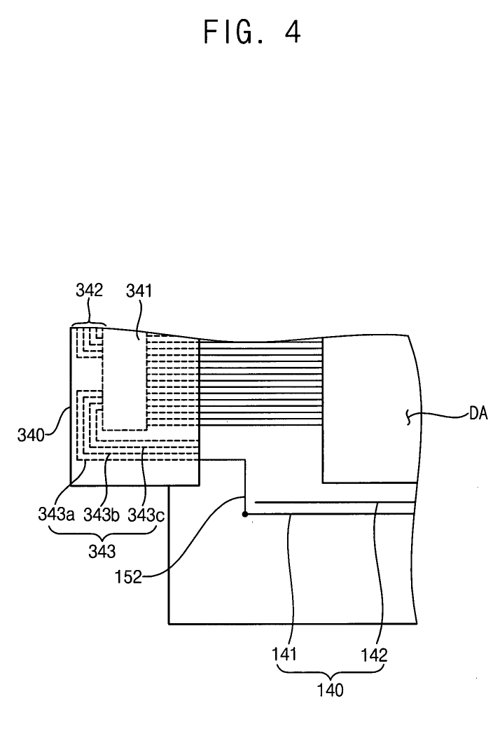

FIG. 3 is an enlarged view of portion ‘II’ shown in FIG. 1, and FIG. 4 is an enlarged view of portion ‘III’ shown in FIG. 1.

Referring to FIGS. 1, 3, and 4, a sub path, where a gate-on voltage VON outputted from the driving circuit unit 230 is transmitted to a plurality of gate TCPs, includes, in part, a second output line 203, the last data TCP 460, an auxiliary line 141, and the last gate TCP 340.

The last data TCP 460 includes a data driver chip 461, a dummy pattern unit 462, an input pattern unit 463 electrically coupled to an input terminal of the data driver chip 461, and an output pattern unit 464 electrically coupled to an output terminal of the data driver chip 461. As illustrated, the dummy pattern unit 462 does not pass through the data driver chip 461. A first end of the last data TCP 460 is electrically coupled to the source PCB 200, and a second end of the last data TCP 460 is coupled to the lower substrate 110.

The data driver chip 461 converts a data signal received from the driving circuit unit 230 through the input pattern unit 463 to an analog data voltage to apply the analog data voltage to a data line DL of the display panel 100 via the output pattern unit 464.

The dummy pattern unit 462 includes a plurality of dummy patterns. A first end of the arbitrary dummy pattern 462a among the dummy patterns is electrically coupled to the second output line 203 transmitting the gate-on voltage VON from the driving circuit unit 230 formed at the source PCB 200. A second end of the arbitrary dummy pattern 462a is electrically coupled to the third connect line 153 formed on the lower substrate 110.

The lower substrate 110 includes the repairing line unit 140 surrounding the display region DA for displaying an image, such as along first, second, and fourth sides of the display panel 100 as previously described. The repairing line unit 140 includes repair lines 141 and 142, and an auxiliary line 141 of the repair lines 141, 142 is electrically coupled to the third connect line 153. The auxiliary line 141 receives the gate-on voltage VON provided from the second output line 203 of the driving circuit unit 230 to the dummy pattern 462a and the third connect line 153.

As shown in FIG. 4, the last gate TCP 340 includes a gate driver chip 341, an input pattern unit 342, and an output pattern unit 343.

The input pattern unit 342 receives gate control signals from the output pattern unit of the gate TCP 330. The gate driver chip 341 generates gate signals based on the gate control signals transmitted from the input pattern unit 342. The gate driver chip 341 outputs the gate signals to corresponding gate lines GL formed in the display panel 100.

The output pattern unit 343 includes a first output pattern 343a outputting a gate-on voltage VON, a second output pattern 343b outputting a gate-off voltage VOFF, and a third output pattern 343c outputting a clock signal. The first output pattern 343a is electrically coupled to the auxiliary line 141 of the repairing line unit 140 surrounding the display region DA, via the second connect line 152 formed on the lower substrate 110.

Thus, the gate-on voltage VON from the second output line 203 is applied to the first output pattern 343a via the auxiliary line 141. Therefore, the gate-on voltage VON transmitted through the auxiliary line 141 is applied to the gate TCPs 310, 320, 330 and 340 that are electrically coupled to one another.

The second output pattern 343b and the third output pattern 343c of the output pattern unit 343 are electrically opened.

A sub path is thus defined that includes, in part, a second output line 203, the dummy pattern 462a that passes through the last data TCP 460, the third connect line 153, the auxiliary line 141, the second connect line 152, and the output pattern unit on the last gate TCP 340. As described above, the sub path may apply the gate-on voltage VON to a plurality of gate TCPs 310, 320, 330 and 340 by using the dummy pattern 462a of the last data TCP 460 and the auxiliary line 141 among the repair lines of the repairing line unit 140.

When the gate-on voltage transmitted through the first data TCP 410 of the main path is abnormal, the plurality of the gate TCPs 310, 320, 330 and 340 may still receive a normal gate-on voltage by using the gate-on voltage transmitted through the last data TCP 460 of the sub path. Therefore, drive reliability may be improved by providing a sub path distinct and separate from the main path. Thus, the gate-on voltage is provided redundantly through different data TCPs to the gate TCPs to ensure the receipt of the gate-on voltage by the gate TCPs.

In alternative embodiments, the sub path may employ one of the data TCPs 420, 430, 440 and 450 (not including the first data TCP 410) instead of using the last data TCP 460 as the sub path, as in the illustrated embodiment of the present invention. In such embodiments, the second output line 203 and the third connect line 153 would be electrically connected to input and output ends of a dummy pattern provided on one of the other data TCPs 420, 430, 440, or 450. The third connect line 153 would then be connected to the auxiliary line 141 that extends adjacent the first side of the display panel 100.

Alternatively, the sub path may employ an additional auxiliary line so as to electrically couple the last gate TCP 340 to one of the data TCPs 420, 430, 440 and 450 instead of using the repair line as in the illustrated embodiment of the present invention.

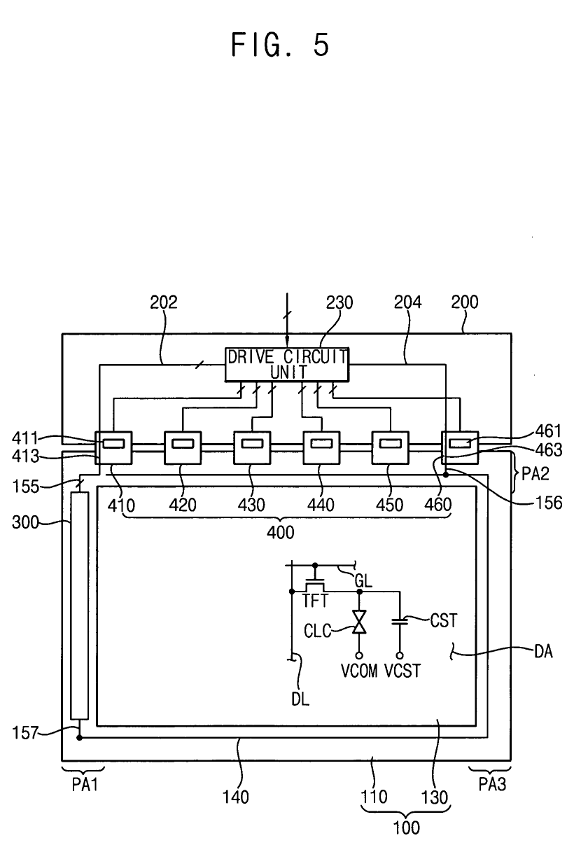

FIG. 5 is a plan view schematically illustrating another exemplary embodiment of a display panel assembly according to the present invention. In the display panel assembly in FIG. 5, the same reference numerals are used to refer to the same elements as in FIG. 1.

Referring to FIG. 5, the display panel assembly includes a display panel 100, a source PCB 200, a driving circuit unit 230, a repairing line unit 140, a gate driver 300, and a data driver 400.

The display panel 100 includes a lower substrate 110, an upper substrate 130, and a liquid crystal layer (not shown) placed between the lower substrate 110 and the upper substrate 130. The lower substrate 110 includes a plurality of gate lines GL arranged along a first direction and a plurality of data lines DL arranged along a second direction.

The lower substrate 110 includes a plurality of pixels each formed by an adjacent pair of the gate lines GL and an adjacent pair of the data lines DL, the pixels including a switching device TFT, a pixel electrode of a liquid crystal capacitor CLC, and a storage capacitor CST. The pixels are formed in a display region DA where an image is substantially displayed in an entire region of the upper substrate 130.

The upper substrate 130 is combined with the lower substrate 110, and the liquid crystal layer is disposed between the upper substrate 130 and the lower substrate 110. The upper substrate 130 includes a common electrode that corresponds to the pixel electrode of the lower substrate 110. The upper substrate 130 is correspondingly disposed to the display region DA.

The display panel 100 may be generally rectangular as illustrated, and includes a first side and an opposite second side, a third side connecting the first side and the second side, and a fourth side connecting the first side and the second side and opposite the third side. The source PCB 200 is disposed in a peripheral region of the display panel 100 adjacent the first side of the display panel 100, and the driving circuit unit 230 is formed on the source PCB 200.

The source PCB 200 includes a plurality of output lines corresponding to an output terminal of the driving circuit unit 230. In detail, the output terminal of the driving circuit unit 230 outputs gate driving voltages, and is coupled to a first output line 202 and a second output line 204, respectively.

The first output line 202 is electrically coupled to a dummy pattern unit 413 of the first data TCP 410, and the second output line 204 is electrically coupled to a dummy pattern unit of another data TCP not including the first data TCP 410.

The gate driving voltages includes a first clock signal CKV, a second clock signal CKVB having an inverted polarity of the first clock signal CKV, an off voltage VSS, and a vertical start signal STV.

For example, the second output line 204 is electrically coupled to the dummy pattern unit 463 of the last data TCP 460. Thus, the gate driving voltages are applied to the dummy pattern unit 413 of the first data TCP 410 and the dummy pattern unit 463 of the last data TCP 460 via the first output line 202 and the second output line 204, respectively.

The driving circuit unit 230 outputs a driving signal for driving the display panel 100 based on a signal provided from an external device as illustrated by the arrow into the driving circuit unit 230. Particularly, the driving circuit unit 230 outputs a gate driving voltage to the gate driver 300, and outputs data signals to the data TCPs 410 through 460.

The repairing line unit 140 is disposed in a peripheral region of the display region DA such that the repairing line unit 140 surrounds the display region DA, such as along first, second, and fourth sides of the display panel 100. A number of lines within the repairing line unit are more than two.

The repairing line unit 140 is electrically coupled to the dummy pattern unit 463 of the last data TCP 460 via a connection line unit 156. The repairing line unit 140 receives the gate driving voltage provided from the second output line 204 via the dummy pattern unit 463 and the connection line unit 156.

The gate driver 300 includes a shift register having a plurality of stages formed in a first peripheral region PA1 of the lower substrate 110 adjacent the third side of the display panel 100. The gate driver 300 is disposed in the first peripheral region PA1 of the lower substrate 110.

A first input terminal 155 is disposed adjacent to the gate driver 300, and the first input terminal 155 receives a gate driving voltage corresponding to a first stage of the gate driver 300. The first input terminal 155 is positioned relative to a first end of the gate driver 300 closer to the source PCB 200 than a second end of the gate driver 300. The first input terminal 155 is electrically coupled to the dummy pattern unit 413 of the first data TCP 410, and receives the gate driving voltage.

The gate driving voltage includes a first clock signal CKV, a second clock signal CKVB, a gate-off voltage VSS, and a vertical start signal STV.

A second input terminal 157 is disposed adjacent to the second end of the gate driver 300, and the second input terminal 157 receives the gate driving voltage corresponding to the last stage of the gate driver 300. The second input terminal 157 is electrically coupled to the repairing line unit 140. Thus, the gate driving voltage applied to the repairing line unit 140 via the second output line 204, dummy pattern unit 463, and connection line unit 156 is provided to the second input terminal 157. For example, the second input terminal 157 includes input terminals where the first clock signal CKV and the second clock signal CKVB are inputted.

The data driver 400 includes a plurality of data TCPs 410, 420, 430, 440, 450 and 460. The data TCPs 410, 420, 430, 440, 450 and 460 are arranged along the second direction at a second peripheral region PA2 of the lower substrate 110 and positioned along a first side of the display panel 100.

Each of the data TCPs includes a data driver chip outputting a data signal to a data line. Each of the data TCPs includes an input pattern unit where a signal is inputted, an output pattern unit where a processed signal is outputted. At least the data TCP 410 further includes a dummy pattern unit 413.

The first input terminal 155 of the gate driver 300 receives the gate driving voltage via the dummy pattern unit 413 of the first data TCP 410. The repairing line unit 140 receives the gate driving voltage via the dummy pattern unit 463 of the last data TCP 460, and the gate driving-voltage provided to the repairing line unit 140 is applied to the second input terminal 157 of the gate driver 300.

As described above, the gate driving voltage outputted from the driving circuit unit 230 is applied to the first input terminal 155 of the gate driver 300 via the first output line 202 and the first data TCP 410 that are defined as the ‘main path’.

In addition, the gate driving voltage is applied to the second input terminal 157 of the gate driver 300 via the second output line 204, the last data TCP 460 and the repairing line unit 140 that are defined as the ‘sub path’.

In alternative embodiments, another data TCP may be employed as the sub path instead of using the last data TCP as in the illustrated embodiment of the present invention.

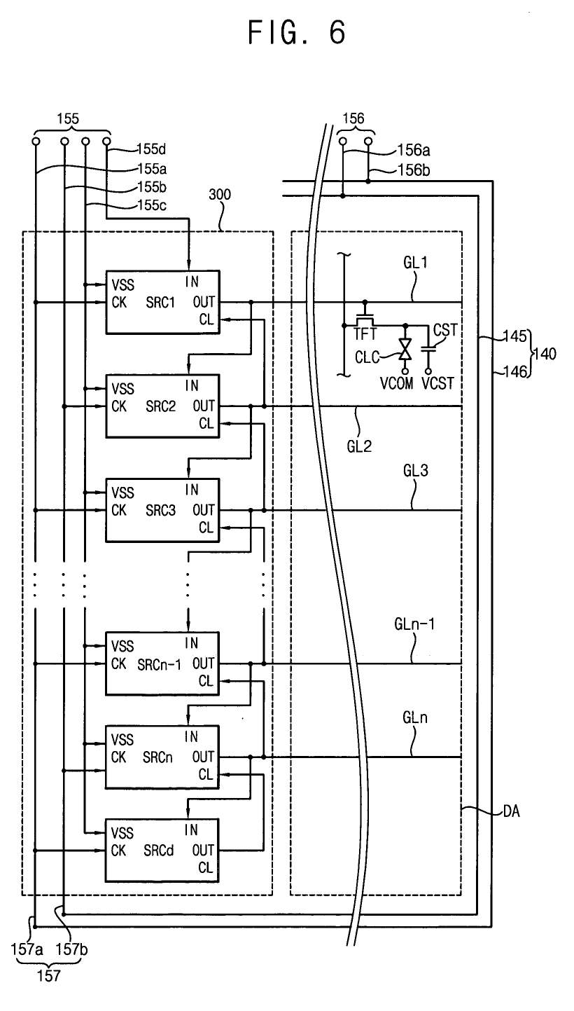

FIG. 6 is a block diagram illustrating an exemplary gate driver circuit shown in FIG. 5 and an exemplary transmission path of a driving voltage.

Referring to FIG. 6, the gate driver 300 includes an n-number of stages SRC1 through SRCn and a dummy stage SRCd that are electrically coupled to one another.

The stages include thin film transistors TFTs, input terminals, and output terminals. The input terminals include an input terminal IN receiving a vertical start signal STV if the input terminal IN is in the first stage SRC1 or an output signal of the previous stage if the input terminal IN is in another stage not including the first stage SRC1, a control terminal CL receiving an output signal of the next stage or an output signal of the dummy stage SRCd, a clock terminal CK receiving the first clock signal CKV or the second clock signal CKVB, and a voltage terminal VSS receiving an off voltage VSS.

The first clock signal CKV is applied to odd-numbered stages, and the second clock signal CKVB is applied to even-numbered stages. The output terminal is electrically coupled to corresponding gate lines GL to output a gate signal.

Referring to FIGS. 5 and 6, the gate driving voltage is applied to the gate driver 300 via the first input terminal 155 corresponding to the first stage SRC1 and a second input terminal 157 corresponding to the last stage, or, as previously described, an alternate stage other than the first stage SRC1.

In detail, the gate driving voltage is applied to the gate driver 300 via the main path and the sub path.

The main path includes the first output line 202 formed in the source PCB 200, the first dummy pattern unit 413 of the first data TCP 410 and the first input terminal 155. For example, the first input terminal 155 corresponds to the first stage SRC1.

The gate driving voltage transmitted from the first output line 202 is applied to the first input terminal 155 via the first dummy pattern unit 413. Thus, the gate driving voltage is applied to the gate driver 300. For example, the gate driving voltage applied to the first input terminal 155 includes the first clock signal CKV, the second clock signal CKVB, the gate-off voltage VSS, and the vertical start signal STV.

The first output line 202 includes a plurality of lines corresponding to the first clock signal CKV, the second clock signal CKVB, the gate-off voltage VSS, and the vertical start signal STV, and the first dummy pattern unit 413 includes a plurality of dummy patterns, such as one dummy pattern for each of the first clock signal CKV, the second clock signal CKVB, the gate-off voltage VSS, and the vertical start signal STV.

The first input terminal 155 includes input terminals 155a, 155b, 155c, and 155d corresponding to the gate driving voltage where the gate driving voltage includes the first clock signal CKV, the second clock signal CKVB, the gate-off voltage VSS, and the vertical start signal STV.

The gate driving voltage outputted from the driving circuit unit 230 is applied to the gate driver 300 via the main path, defined in part by the first output line 202, the first dummy pattern unit 413, and the first input terminal 155, to generate gate signals, and the gate signals are applied to corresponding gate lines GL.

The sub path includes the second output line 204 formed in the source PCB 200, the second dummy pattern unit 463 of the second data TCP 460, the connection line unit 156, the repairing line unit 140, and the second input terminal 157.

For example, the second input terminal 157 corresponds to one of the stages not including the first stage.

The sub path may further include a connection line unit 156 for electrically coupling the first dummy pattern unit 463 to the repairing line unit 140.

The gate driving voltage transmitted through the second output line 204 is applied to the second dummy pattern unit 463, and the gate driving voltage applied to the second dummy pattern unit 463 is applied to the repairing line unit 140 via the connection line unit 156.

The gate driving voltage applied to the repairing line unit 140 is applied to the second input terminal 157 of the gate driver 300. Thus, the gate driving voltage is applied to the gate driver 300. For example, the gate driving voltage applied to the second input terminal 157 includes the first clock signal CKV and the second clock signal CKVB.

The second output line 204 includes a plurality of lines corresponding to the first clock signal CKV and the second clock signal CKVB, and the second dummy pattern unit 463 includes a plurality of dummy patterns, such as one dummy pattern for each of the first clock signal CKV and the second clock signal CKVB.

The second input terminal 157 includes input terminals 157a and 157b corresponding to the first clock signal CKV and the second clock signal CKVB.

When the first clock signal CKV and the second clock signal CKVB are not normally transmitted to the gate driver 300 via the main path, the sub path may be employed so as to normally transmit the first clock signal CKV and the second clock signal CKVB to the gate driver 300.

Alternatively, the sub path may be formed for transmitting the vertical start signal STV and the off voltage signal VSS to the gate driver 300 as well as the sub path used for transmitting the first clock signal CKV and the second clock signal CKVB to the gate driver 300.

For example, the vertical start signal STV may be applied to the first stage via the repairing line as the sub path, and the off voltage VSS may be applied to the last stage as the sub path.

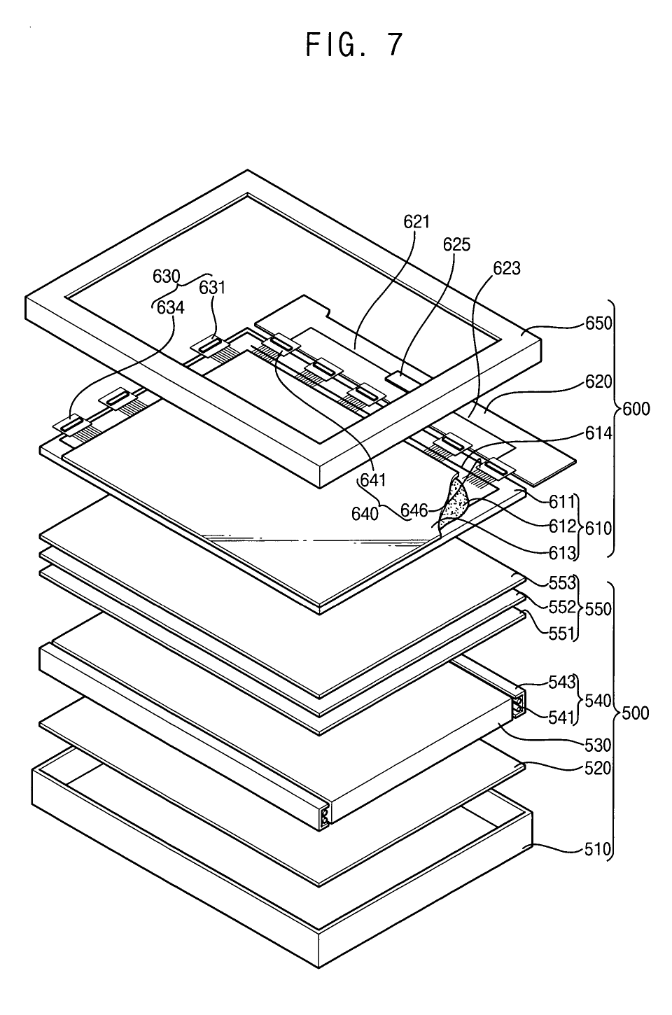

FIG. 7 is an exploded perspective view schematically showing an exemplary embodiment of a display apparatus according to the present invention.

Referring to FIG. 7, the display apparatus includes a backlight assembly 500 and a display panel assembly 600.

The backlight assembly 500 includes a bottom chassis 510, a reflection member 520, a light guide plate (“LGP”) 530, a lamp unit 540, and an optical member 550.

The bottom chassis 510 includes a bottom plate and sidewalls extended from edge portions of the bottom plate. An inverter for providing a power voltage to the lamp unit 540 and a source PCB of the display panel assembly are disposed on a back side of the bottom plate of the bottom chassis 510. The bottom chassis 510 receives the reflection member 520 and the lamp unit 540.

The reflection member 520 is received in the bottom chassis 510, and reflects a light emitted from the lamp unit 540. The LGP 530 guides a light exited from the lamp unit 530 toward the display panel assembly 600. The lamp unit 540 includes a light source 541 emitting a light and a lamp cover 543 covering the light source 541. While the light source 541 is illustrated as emitting light to an edge of the LGP 530, the light source 541 may alternatively be positioned between the LGP 530 and the reflection member 520 to emit light into a rear surface of the LGP 530.

The optical member 550 is disposed on an upper layer of the LGP 530, and improves luminance of a light guided by the LGP 530. The optical member 550 includes a plurality of sheets 551, 552, and 553 including a diffusion sheet and at least one prism sheet. While an optical member 550 with three sheets is illustrated, it should be understood that other display apparatuses may include more or less sheets within the optical member 550 for achieving varying optical properties, and other display apparatuses may eliminate the optical member 550 entirely.

The display panel assembly 600 includes a display panel 610, a source PCB 620, a plurality of gate TCPs 630, a plurality of data TCPs 640, and a top chassis 650.

The display panel 610 includes a lower plate 611, an upper plate 613, and a liquid crystal layer 612. The lower plate 611 includes a display region having a plurality of switching elements coupled to a plurality of gate lines and a plurality of data lines, and a peripheral region surrounding the display region. The upper plate 613 contains the liquid crystal layer 612 by combining with the lower plate 611 such as by a sealing portion surrounding a periphery of the upper or lower plate 613, 611.

The source PCB 620 is disposed at a peripheral region of the display panel 610, such as along a first side of the display panel 610, a driving circuit unit 625 is disposed on the source PCB 620 and converts input signals received from an external device to a drive signal for driving the display panel 610.

A plurality of lines is disposed on the driving circuit unit 625 and transmits the drive signal outputted from the driving circuit unit 625 to the display panel 610. In detail, a first output line 621 and a second output line 623 transmitting a gate-on voltage to the display panel 610 are formed on the source PCB 620. Although not illustrated, other output lines of the driving circuit unit 625 may apply data signals to input pattern units electrically coupled to data driver chips within each of the data TCPs.

Each of the gate TCPs 631 and 634 includes a gate driver chip for applying gate signals to the gate lines, respectively and is disposed at a peripheral region of the lower plate 611, such as along a third side of the display panel 610.

A gate driving signal outputted from the driving circuit unit 625 is applied successively to all of the gate TCPs 630 via the first gate TCP 631.

Each of the data TCPs 641 and 646 includes a data driver chip for outputting an analog-type data voltage, respectively, and is disposed at another peripheral region of the lower plate 611 adjacent the third side of the display panel 610.

The gate driving signal is transmitted to the first gate TCP 631 via a dummy pattern of the first data TCP 641. That is, the dummy pattern of the first data TCP 641 is used as a main path for transmitting the gate-on voltage transmitted from the first output line 621 to the gate TCPs 630.

A dummy pattern of the last data TCP 646 is used as a sub path for transmitting the gate-on voltage transmitted from the second output line 623 to the gate TCPs 630.

In alternative embodiments, the sub path may be defined using another data TCP not including the first data TCP 641, instead of using the last data TCP 646 as in the illustrated embodiment of the present invention.

In detail, the dummy pattern of the last data TCP 646 is electrically coupled to one i.e., an auxiliary line 614, of the repair lines surrounding a portion of the display region, such as adjacent first, second, and fourth sides of the display panel 610. The last gate TCP 634 is electrically coupled to the auxiliary line 614.

Thus, the gate-on voltage transmitted from the second output line 623 is transmitted to the gate TCPs 630 via the dummy pattern of the last data TCP 646, the auxiliary line 614, and the last gate TCP 634.

The repair lines are used for repair in the event the data lines are disconnected. The top chassis 650 is formed on an upper region of the display panel 610, and is coupled to the bottom chassis 510 of the backlight assembly 500.

As described above, drive reliability may be improved by providing a driving voltage to the gate driver through the sub path as well as the main path employing the dummy pattern of the first data TCP.

In detail, the sub path uses the repair lines surrounding the display region in order that the dummy pattern of another data TCP not including the first data TCP and data lines are repaired.

As a result, the additional sub path may stably transmit a normal driving voltage to the gate driver in the event an error occurs in the main path.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A display panel assembly comprising:
a display panel displaying an image in response to a data signal and a gate signal generated from a driving voltage;
a source printed circuit board disposed at a peripheral region of the display panel and having a driving circuit unit, the driving circuit unit outputting the driving voltage;
a main path unit transmitting the driving voltage to the display panel; and a sub path unit transmitting the driving voltage to the display panel.

2. The display panel assembly of claim 1, wherein the main path unit comprises:
a first output line unit transmitting the driving voltage outputted from the driving circuit unit to a first data tape carrier package; and
a first connect line unit applying the driving voltage transmitted from the first data tape carrier package to a first gate tape carrier package.

3. The display panel assembly of claim 2, wherein the first output line unit and the first connect line unit are electrically coupled to each other via a dummy pattern unit of the first data tape carrier package.

4. The display panel assembly of claim 1, wherein the sub path unit comprises:
a second output line unit transmitting the driving voltage outputted from the driving circuit unit to a second data tape carrier package; and
a second connect line unit transmitting the driving voltage outputted from the second data tape carrier package to a second gate tape carrier package.

5. The display panel assembly of claim 4, wherein the second output line unit and the second connect line unit are electrically coupled to each other via a dummy pattern unit of the second data tape carrier package.

6. The display panel assembly of claim 4, wherein the second connect line unit comprises:
a repairing line unit surrounding a portion of a display region of the display panel for displaying an image; and
a third connect line unit coupling the repairing line unit to the second gate tape carrier package.

7. The display panel assembly of claim 1, wherein the display panel includes a display region for displaying an image and a peripheral region surrounding the display region, and the peripheral region includes a gate driver having a plurality of stages electrically coupled to one another and applying the gate signal to the display region of the display panel.

8. The display panel assembly of claim 7, wherein the main path unit comprises:
a first output line unit transmitting the driving voltage outputted from the driving circuit unit to a first data tape carrier package; and
a first input terminal unit applying the driving voltage transmitted from the first data tape carrier package to a first stage of the plurality of stages.

9. The display panel assembly of claim 8, wherein the first output line unit and the first input terminal unit are electrically coupled to each other via a dummy pattern unit of the first data tape carrier package.

10. The display panel assembly of claim 8, wherein the sub path unit comprises:
a second output line unit transmitting the driving voltage outputted from the driving circuit unit to a second data tape carrier package;
a second connect line unit transmitting the driving voltage transmitted from the second data tape carrier package to the gate driver; and
a second input terminal unit transmitting the driving voltage transmitted from the second connect line unit to a second stage of the plurality of stages.

11. The display panel assembly of claim 10, wherein the second connect line unit includes a repairing line unit surrounding a portion of the display region.

12. The display panel assembly of claim 11, wherein the repairing line unit repairs data lines formed in the display region.

13. The display panel assembly of claim 1, wherein the main path unit extends between a first data tape carrier package and a first gate tape carrier package, and the sub path unit extends between a second data tape carrier package and a second gate tape carrier package.

14. The display panel assembly of claim 1, wherein the sub path unit surrounds a plurality of sides of a display region of the display panel.

15. The display panel assembly of claim 14, wherein the display panel includes a first side, a second side, a third side, and a fourth side, the first side opposite the second side and the third side opposite the fourth side, the source printed circuit board positioned adjacent the first side of the display panel, a gate driver positioned adjacent the third side of the display panel, and the sub path unit extending adjacent the second and fourth sides of the display panel.

16. The display panel assembly of claim 1, wherein, if an error occurs in the main path unit, the sub path unit transmits the driving voltage.

17. A display panel assembly comprising:
a driving circuit unit mounted on a source printed circuit board disposed in a peripheral region of a display panel, the driving circuit unit outputting a driving voltage to the display panel;
a first output line unit transmitting the driving voltage outputted from the driving circuit unit to a first data tape carrier package;
a second output line unit transmitting the driving voltage outputted from the driving circuit unit to a second data tape carrier package;
a gate driver outputting a gate signal to a display region of the display panel based on the driving voltage; and
a repairing line unit transmitting the driving voltage transmitted from the second data tape carrier package to the gate driver.

18. The display panel assembly of claim 17, wherein the gate driver includes a plurality of gate tape carrier packages.

19. The display panel assembly of claim 18, wherein the driving voltage applied to the first data tape carrier package is transmitted to a first gate tape carrier package, and the driving voltage applied to the second data tape carrier package is transmitted to a second gate tape carrier package.

20. The display panel assembly of claim 17, wherein the gate driver includes a shift register having a plurality of stages electrically coupled to one another.

21. The display panel assembly of claim 20, wherein the driving voltage transmitted to the first data tape carrier package is applied to a first stage of the shift register, and the driving voltage transmitted to the second data tape carrier package is applied to a second stage of the shift register.

22. A display apparatus comprising:
a display panel assembly having:
a driving circuit unit mounted on a source printed circuit board disposed at a peripheral region of a display panel, the driving circuit unit outputting a driving voltage;
a gate driver outputting a gate signal to a display region of the display panel based on the driving voltage;
a main path unit transmitting the driving voltage to the gate driver; and
a sub path unit transmitting the driving voltage to the gate driver; and
a backlight assembly emitting a light to the display panel.

23. The display apparatus of claim 22, wherein the main path unit includes a first output line unit disposed at the source printed circuit board and transmitting the driving voltage outputted from the driving circuit unit to a first data tape carrier package.

24. The display apparatus of claim 23, wherein the sub path unit comprises:
a second output line unit disposed on the source printed circuit board and transmitting the driving voltage outputted from the driving circuit unit to a second data tape carrier package; and
a repairing line unit disposed on the display panel and transmitting the driving voltage transmitted from the second data tape carrier package to the gate driver.

25. The display apparatus of claim 22, wherein the gate driver includes a plurality of gate tape carrier packages.

26. The display apparatus of claim 22, wherein the gate driver includes a shift register having a plurality of stages that are electrically coupled to one another.

27. A display panel assembly comprising:
a main path unit transmitting a driving voltage to a first portion of a gate driver; and,
a sub path unit transmitting the driving voltage to a second portion of the gate driver, the sub path unit including an auxiliary line within a repairing line unit.

28. The display panel assembly of claim 27, wherein the first portion is a first gate tape carrier package and the second portion is a second gate tape carrier package.

29. The display panel assembly of claim 27, wherein the gate driver includes a plurality of shift registers, the first portion is a first input terminal on a first end of the gate driver, and the second portion is a second input terminal on a second end of the gate driver.

30. The display panel assembly of claim 27, wherein the main path unit extends from a first data tape carrier package, and the sub path unit extends from a second data tape carrier package.

31. The display panel assembly of claim 27, further comprising a source printed circuit board disposed on a first side of the display panel, a driving circuit unit outputting the driving voltage disposed on the source printed circuit board, wherein the gate driver is disposed on a third side of the display panel, and the sub path unit extends adjacent a fourth side of the display panel opposite the third side and further extends adjacent a second side of the display panel opposite the first side.
